(19) United States
(12) Patent Application Publication
(10) Pub. No.: US 2007/0035644 A1
(43) Pub. Date: Feb. 15, 2007

(54) METHOD OF VIDEO SYNC PROTECTION AND VIDEO SYNC PROTECTOR THEREOF

(76) Inventors: Chih-Hui Kuo, Hsin-Chu City (TW); Cheng-Tsai Ho, Tai-Chung City (TW); Chih-Wei Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,980

(22) Filed: Jul. 19, 2005

(51) Int. Cl. H04N 5/247

(52) U.S. Cl. 348/264

(57) ABSTRACT

A method of protecting a video encoder while encoding video data corresponding to a first video signal includes receiving the first video signal; detecting a start of a first field in the first video signal; outputting information corresponding to the first field in the first video signal as a first field in a second video signal; and waiting at least a minimum field duration from a start of the first field in the second video signal before outputting information of a second field in the second video signal. The method increases the stability of the video encoder and also prevents erroneous data from being encoded by the video encoder during channel switches that cause sync signal timing differences in the first video signal.

### BACKGROUND

The invention relates to encoding video data, and more particularly, to protecting a video encoder from receiving abnormal video signals when encoding an incoming video bit stream.

At its most basic level, video compression involves analyzing an input video sequence and discarding information that is indiscernible to a viewer. Each video event is then assigned a code—commonly occurring events are assigned few bits and rare events will have codes with more bits. These steps are commonly called signal analysis, quantization and variable length encoding respectively. As is well known to a person of ordinary skill in the art, there are four methods for compression, namely: discrete cosine transform (DCT), vector quantization (VQ), fractal compression, and discrete wavelet transform (DWT).

The Moving Picture Experts Group (MPEG) is an ISO/IEC working group established in 1988 to develop standards for digital audio and video formats. There are currently five MPEG standards being used or in development. Each compression standard was designed with a specific application and bit rate in mind, although MPEG compression scales well with increased bit rates.

One example of the MPEG standards is MPEG-2. MPEG-2 fixes many of the problem inherent in a previous standard MPEG-1, such as resolution, scalability and handling of interlaced video. Additionally, MPEG-2 allows for a much better picture (studio quality and up to HDTV levels), allows multiple channels at various bit rates to be multiplexed into a single data stream, and also provides support for interlaced video (the format used by broadcast TV systems). MPEG-2 was officially adopted by ISO using the catalog number ISO 13818-1 and is typically used to encode audio and video for broadcast signals, including digital satellite and Cable TV. Furthermore, with some modifications, MPEG-2 is also the coding format used by standard commercial DVD movies.

In MPEG-2, an incoming video image (frame) is separated into one luminance (Y) and two chrominance channels (also called color difference signals U and V). The image is also divided into “macroblocks”, which are the basic unit of coding within the picture (i.e., within the frame). Each macroblock is divided into four 8×8 luminance blocks. The number of 8×8 chrominance blocks per macroblock depends on the chrominance format of the source image. For example, in the common 4:2:0 format, there is one chrominance block per macroblock for each of the channels, making a total of six blocks per macroblock.

All macroblocks for each frame in a video bit stream are processed during a video compression (encoding) operation. For example, the actual image data of Inter-coded (I) pictures directly passes through the MPEG-2 encoding process. Forward predicted (P) and bidirectional predicted (B) pictures are first subjected to a process of “motion compensation”, in which they are correlated with the previous (and in the case of B pictures, the next) image. Each macroblock in the P or B picture is then associated with an area in the previous or next image that is well-correlated with it. The “motion vector” that maps the macroblock to its correlated area is encoded, and then the difference between the two areas is passed through an encoding process.

FIG. 1 shows a typical block diagram of a video compression apparatus 102 such as an MPEG video encoder receiving a video signal S from a video apparatus 100 such as a TV decoder. In video applications, the video signal S shown in FIG. 1 is often implemented as a CCIR 656 format video signal. The CCIR 656 format is defined for parallel and serial interfaces and allows transmission of 4:2:2 YCbCr digital video between equipment in studio and pro-video applications. Active video resolutions are either 720×486 for North American NTSC systems (525 lines/60 Hz video), or 720×576 for European PAL system (625 lines/50 Hz video).

FIG. 2 shows the format of the CCIR 656 video signal S transmission according to the related art. To implement an interlacing function, as shown in FIG. 2, there are two interlaced fields f1, f2. Additionally, there are horizontal synchronization (Hsync) signals and vertical synchronization (Vsync) signals used to indicate the active video A₁, A₂ in each of the fields f1, f2. It is the active video A₁, A₂ that forms the visible content and is encoded by the video compression apparatus 102.

FIG. 3 shows a diagram of the video synchronization timing changes if the first channel Ch1 is ahead of the second channel Ch2, during which time a channel switch occurs. In FIG. 3, there is a timing difference between the first channel Ch1 and the second channel Ch2, the first channel Ch1 being ahead of the second channel Ch2. The vertical sync Vsync is assumed to occur at the beginning of each field f1, f2 in the respective channels and indicates that a new interlaced field is starting. When the video signal S of FIG. 1 is switched from the first channel Ch1 to the second channel Ch2, as shown in FIG. 3, there are four possible resulting video signals R1, R2, R3, and R4. Depending on when the channel switch occurs, different abnormal vertical syncs Vsync (and horizontal syncs Hsync) are caused. For example, the first and third resulting video signals R1, R3 have shortened fields due to receiving a new Vsync signal in the second channel Ch2 before the Vsync signal would have arrived in the first Ch1. Additionally, the first and third resulting video signals R1, R3 have repeated fields. That is, in the first resulting video signal R1, the first field f1 is repeated after the channel switch occurs at P1; and in the third resulting video signal R3, the second field f2 is repeated after the channel switch occurs at P3. Finally, the second and fourth resulting video signals R2, R4 have extended length fields due to having to wait for a Vsync signal to arrive in the second channel Ch2.

FIG. 4 shows a diagram of the video synchronization timing changes if the first channel Ch1 is behind the second channel Ch2, during which time a channel switch occurs. Similar to that of FIG. 3, the vertical sync Vsync in FIG. 4 is assumed to occur at the beginning of each field f1, f2 in the respective channels and indicates that a new interlaced field is starting. When the video signal S of FIG. 1 is switched from the first channel Ch1 to a second channel Ch2, as shown in FIG. 4 there are four possible resulting video signals R5, R6, R7, R8. Depending on when the channel switch occurs, different abnormal vertical syncs Vsync (and horizontal syncs Hsync) are caused. For example, the first and third resulting video signals R5, R7 have shortened fields due to receiving a new Vsync signal in the second channel Ch2 before the Vsync signal would have arrived in the first Ch1. Additionally, the second and fourth resulting video signals R6, R8 have repeated fields. That is, in the second resulting video signal R6, the first field f1 is repeated after the channel switch occurs at P2; and in the fourth resulting video signal R8, the second field f2 is repeated after the channel switch occurs at P4. Finally, the second and fourth resulting video signals R6, R8 have extended length fields due to having to wait for a Vsync signal to arrive in the second channel Ch2.

The abnormal sync signals and corresponding fields caused by the channel switch may cause problems to the video compression apparatus 102 shown in FIG. 1. In particular, the shortened fields 308, 310, 408, 410 shown in FIG. 3 and FIG. 4 may not allow the video compression apparatus 102 enough time to process all the macroblocks in a current frame before starting the next frame. If the next frame arrives before the video compression apparatus 102 has finished encoding the current frame, the video compression apparatus 102 may malfunction. In this situation, the video compression apparatus 102 may hang unresponsive until the system is reset. A similar stability problem is also experienced for repeated frames. Finally, longer frames 312, 314, 412, 414 could cause erroneous data to be encoded as active video data within the video compression apparatus 102, resulting in undesired black lines or noise to be apparent on playback of the encoded data.

### SUMMARY

According to an exemplary embodiment, a method of protecting a video encoder while encoding video data corresponding to a first video signal is disclosed. The method comprises receiving the first video signal; detecting a start of a first field in the first video signal; outputting information corresponding to the first field in the first video signal as a first field in a second video signal; and waiting at least a minimum field duration from a start of the first field in the second video signal before outputting information of a second field in the second video signal.

According to another exemplary embodiment, a video sync protector for protecting a video encoder while encoding video data corresponding to a first video signal is disclosed. The video sync protector comprises a sync detection unit coupled to the first video signal for receiving video data of the first video signal and detecting a start of a first field in the video data of the first video signal; a field duration counter coupled to the first video signal; and a controller coupled to the first video signal, the sync detection unit, and the field duration counter for outputting information corresponding to the first field in the first video signal as a first field in a second video signal after the sync detection unit detects the first sync signal in the first video signal, and for waiting at least until the field duration counter reaches a minimum field duration before outputting information of a second field in the second video signal.

### BRIEF DESCRIPTION OF THE DRAWINGS

FIG. 1 is a typical block diagram of a video compression apparatus such as an MPEG video encoder receiving a video signal from a video apparatus such as a TV decoder.

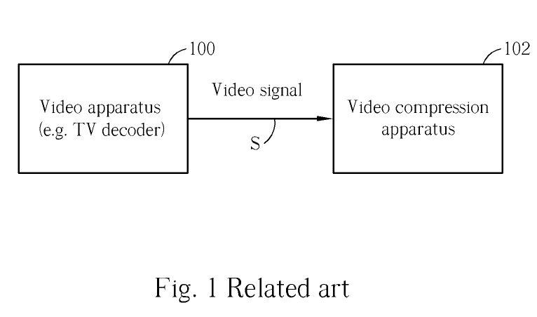

FIG. 2 is the format of the CCIR 656 video signal transmission according to the related art.

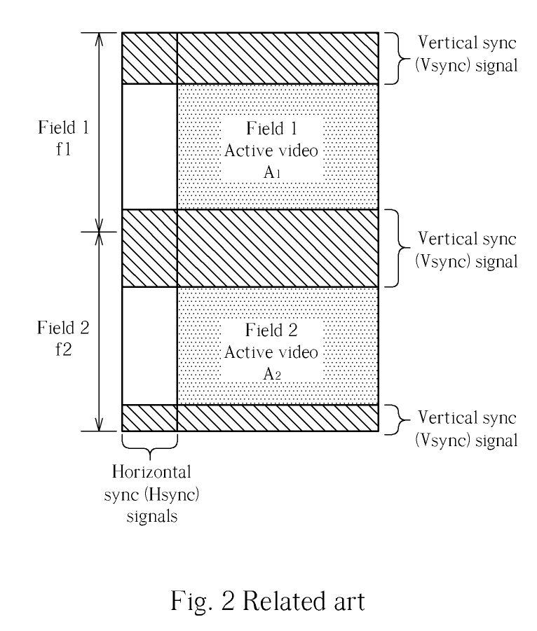

FIG. 3 is a diagram of the video synchronization timing changes if the first channel is ahead of the second channel, during which time a channel switch occurs.

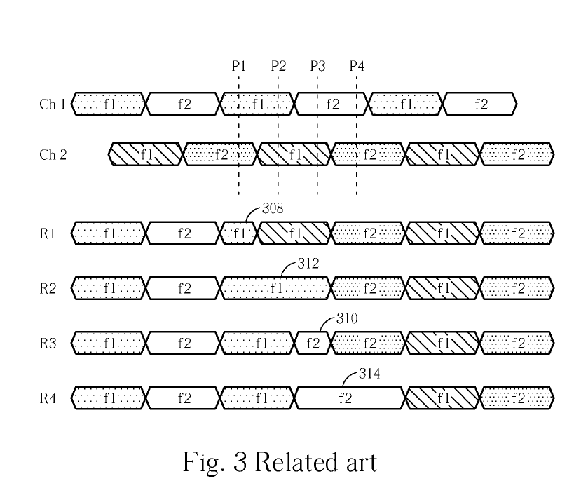

FIG. 4 is a diagram of the video synchronization timing changes if the first channel is behind the second channel, during which time a channel switch occurs.

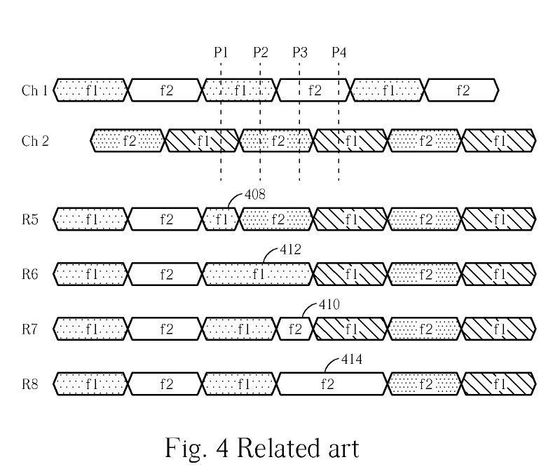

FIG. 5 is a block diagram of a sync protection unit being coupled between a video compression apparatus such as an MPEG video encoder and a video apparatus such as a TV decoder according to an exemplary embodiment.

FIG. 6 is a diagram of abnormal sync signals and corresponding fields that could cause problems to the video compression apparatus.

FIG. 7 is a flowchart describing operations of protecting a video compression apparatus from receiving invalid sync signals when encoding video data corresponding to a first video signal according to a first exemplary embodiment.

FIG. 8 is a diagram of the protected second video signal outputted by the video sync protector of FIG. 5 when operating according to the method described in FIG. 7 for each of the abnormal video signals of FIG. 6.

FIG. 9 is a flowchart describing the wait for field duration to be greater than or equal to the threshold operation step of FIG. 7.

FIG. 10 is a flowchart describing operations of protecting a video encoder from receiving invalid sync signals when encoding video data corresponding to a first video signal according to a second exemplary embodiment.

FIG. 11 is a diagram of the protected second video signal outputted by the video sync protector of FIG. 5 when operating according to the method described in FIG. 10 for each of the abnormal video signals of FIG. 6.

FIG. 12 is a flowchart describing operations of protecting a video encoder from receiving invalid sync signals when encoding video data corresponding to a first video signal according to a third exemplary embodiment.

FIG. 13 is a diagram of the protected second video signal outputted by the video sync protector of FIG. 5 when operating according to the method described in FIG. 12 for each of the abnormal video signals of FIG. 6.

FIG. 14 is a generalized block diagram of the video sync protector of FIG. 5 according to an exemplary embodiment.

FIG. 15 shows a block diagram of a video compression apparatus having an integrated video sync protector according to another exemplary embodiment.

FIG. 16 shows a generalized flowchart describing operations of protecting a video encoder when encoding video data corresponding to a first video signal according to a fourth exemplary embodiment.

### DETAILED DESCRIPTION

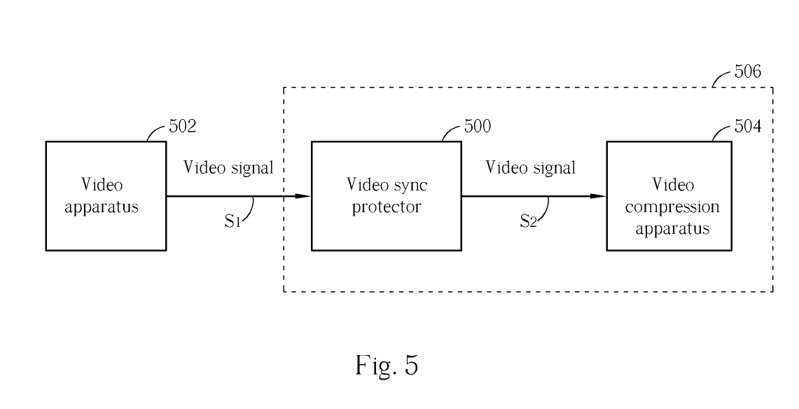

FIG. 5 shows a block diagram of a video sync protector 500 being coupled between a video compression apparatus 504 and a video apparatus 502 such as a TV decoder according to an exemplary embodiment. In some examples, the video compression apparatus 504 is an encoder operative to compress video data according to various standards, such as MPEG-2/4, H.264, and VC-1. The video apparatus 502 outputs a first video signal Si being a CCIR 656 video signal. The video sync protector 500 receives the first video signal S₁ and outputs a corresponding second video signal S₂. The video sync protector 500 protects the video compression apparatus 504 from receiving invalid sync signals by ensuring no harmful invalid sync signals are present in the second video signal S₂. In this way, the video compression apparatus 504 is able to safely and properly record the video data corresponding to the output of the video apparatus 502 including during channel changes on the video apparatus 502.

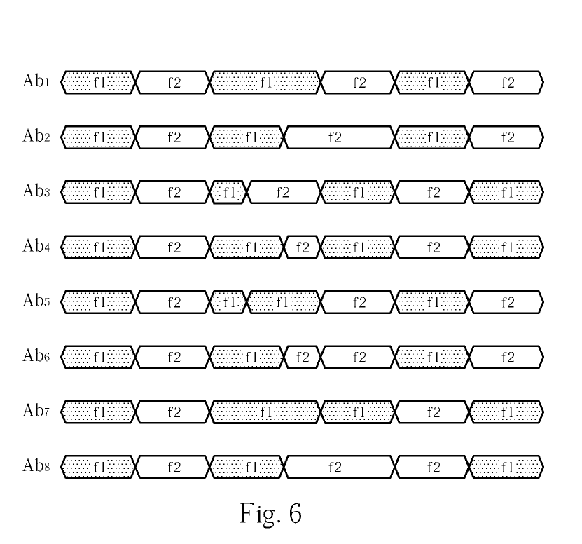

FIG. 6 shows a diagram of abnormal sync signals (Ab1 to Ab8) and corresponding fields f1, f2 that could cause problems to the video compression apparatus 504. That is, shortened fields and repeated fields could cause stability problems to the video compression apparatus 504, and longer fields could cause improper data to be stored by the video compression apparatus 504. In this embodiment, it is important that the video sync protector 500 of FIG. 5 ensure that if any of the abnormal sync signals and corresponding fields of FIG. 6 that cause stability problems are present in the first video signal S₁, that they are removed and not present in the second video signal S₂. Therefore, the video compression apparatus 504 will be able to safely encode the second video signal S2 without periodically hanging due to abnormal sync signals (Ab1 to Ab8).

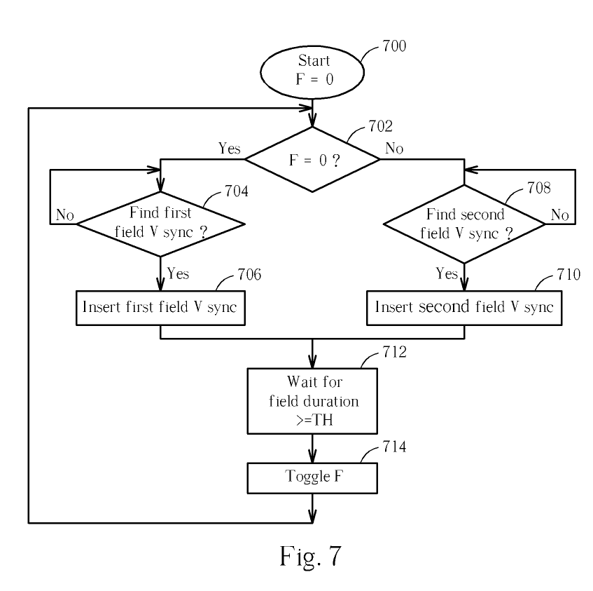

FIG. 7 shows a flowchart describing operations of protecting a video compression apparatus 504 from receiving invalid sync signals when encoding video data corresponding to a first video signal S₁ according to a first exemplary embodiment. Provided that substantially the same result is achieved, the steps of the flowchart shown in FIG. 7 need not be in the exact order shown and need not be contiguous, that is, other steps can be intermediate. In this exemplary embodiment, the operations of protecting a video compression apparatus 504 from receiving invalid sync signals include the following steps:

Step 700: Start sync signal protection operations by setting a field variable F equal to 0. The field variable F corresponds to one of the interlaced fields in the first signal S₁ (either F=0 for the first field f1, or F=1 for the second field f2).

Step 702: Is the field variable F equal to 0? If yes, proceed to step 704; otherwise, proceed to step 708.

Step 704: Find the vertical sync Vsync for the first field f1 in the first video signal S₁. That is, receive the video data of the first video signal S₁ and detect a first sync signal in the received video data. If the vertical sync Vsync for the first field f1 is not found, remain at step 704. When the vertical sync Vsync for the first field f1 in the first signal S₁ is found, proceed to step 706.

Step 706: Insert a first field f1 vertical sync Vsync into the second video signal S₂. In this step, the first field f1 vertical sync Vsync is a protected sync signal in the video data of the second video signal S₂.

Step 708: Find the vertical sync Vsync for the second field f2 in the first video signal S₁. That is, receive the video data of the first video signal S₁ and detect a first sync signal in the received video data. If the vertical sync Vsync for the second field f2 is not found, remain at step 708. When the vertical sync Vsync for the second field f2 in the first video signal S₁ is found, proceed to step 710.

Step 710: Insert a second field f2 vertical sync Vsync into the second video signal S₂. In this step, the second field f2 vertical sync Vsync is a protected sync signal in the video data of the second video signal S₂.

Step 712: Wait for a field duration to exceed a threshold Th to ensure that all fields in the second video signal S₂ are at least as long as the threshold Th. Therefore, no shortened fields will be present in the second video signal S₂. The threshold Th corresponds to a minimum field duration that will allow the video compression apparatus 504 time to fully encode video data for the current field. If the field duration has not exceeded the threshold Th, remain at step 712; otherwise, when the field duration counter has exceeded the threshold Th, proceed to step 714. It should also be noted that during step 712, any incoming sync signals are removed from the first video signal S₁. In this way, invalid sync signals received in the first video signal S₁ are not copied to the second video signal S₂.

Step 714: Toggle the field variable F to ensure that no repeated field vertical sync Vsync signals will be present in the second video signal S₂. Finally, return to step 702 to repeat the process of sync signal protection for the toggled field variable F.

The steps of FIG. 7 ensure that neither shortened fields nor repeated field vertical sync Vsync signals can occur in the second video signal S₂. Shortened fields are prevented because the video sync protector 500 waits for the minimum field duration before outputting a second protected sync signal in the video data of the second video signal S₂ (steps 706 and 710). Repeated field vertical sync Vsync signals are prevented because the video sync protector 500 outputs the protected sync signal in the video data of the second video signal S₂ for the field corresponding to the current state of the field variable F, and the field variable F is toggled each time a protected sync signal is outputted (step 714). As mentioned, shortened and repeated fields are undesirable because they may cause stability problems to the video compression apparatus 504. Therefore, through the operations described in FIG. 7, the video compression apparatus 504 will always be able to safely encode the active video of the two interlaced video fields f1, f2 of the second video signal S2.

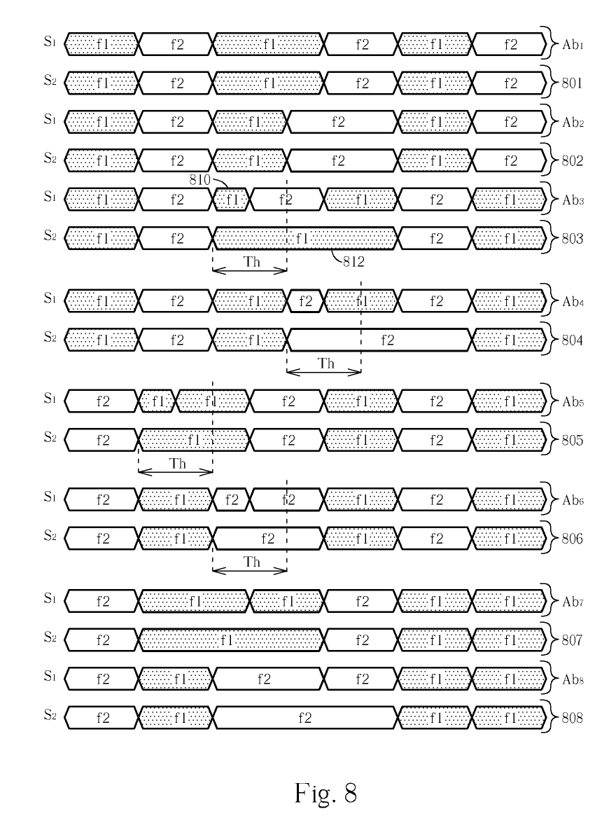

FIG. 8 shows a diagram of the protected second video signal S₂ outputted by the video sync protector 500 when operating according to the method described in FIG. 7 for each of the abnormal video signals (Ab1 to Ab8) of FIG. 6. In this embodiment, the video sync protector 500 receives active video data A₁, A₂ of the first video signal S₁ and outputs the second video signal S₂ having active video data A₁, A₂ corresponding to the active video data A₁, A₂ of the first video signal. As shown in FIG. 8, when the first video signal S₁ is one of the abnormal video signals (Ab1 to Ab8), the video sync protector 500 outputs a second video signal S2 being protected according to the operations described in FIG. 7. That is, the second video signals S₂, labeled in FIG. 8 as 801 to 808, correspond to the protected versions of the abnormal video signals Ab1 to Ab8, respectively. For example, when the first video signal S₁ is the third abnormal video signal Ab3, the video sync protector 500 extends the length of the shortened f1 field 810 by the threshold hold Th, and then waits for the vertical sync Vsync for the second field f2 in the first video signal S₁. Therefore, an extended field 812 results in the second video signal 803. This allows ample time for the video compression apparatus 504 to encode the video data of this field and thereby prevents the video compression apparatus 504 from hanging.

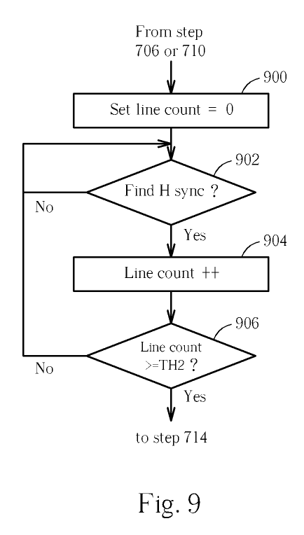

FIG. 9 shows a flowchart describing the wait for field duration to be greater than or equal to the threshold Th operation of step 712 in FIG. 7. In this embodiment, the threshold detection operations could include the following steps:

Step 900: Initialize a line count variable to 0.

Step 902: Find a horizontal sync Hsync in the incoming first video signal S₁. If the horizontal sync Hsync is not found, remain at step 902; otherwise, when the horizontal sync Hsync is found, proceed to step 904.

Step 904: Increment the line count counter by one.

Step 906: Is the line count counter greater than or equal to a second threshold value Th2? If yes, proceed to step 714; otherwise, return to step 902. In this embodiment, the second threshold value Th2 corresponds to a minimum number of lines required to allow the video compression apparatus 504 time to encode all macroblocks in the active video A₁, A₂ of a field. For example, the second threshold value Th2 could be set to 240 lines for NTSC video signals, or 288 lines for PAL video signals.

Although the operations of protecting the video compression apparatus 504 from receiving invalid sync signals described in FIG. 7 will prevent stability problems, in the event of an abnormal video signal Ab1 to Ab2, longer fields could cause erroneous data to be encoded as active video data A₁, A₂ and may result in unpleasant black lines or noise to be apparent on playback of the encoded data.

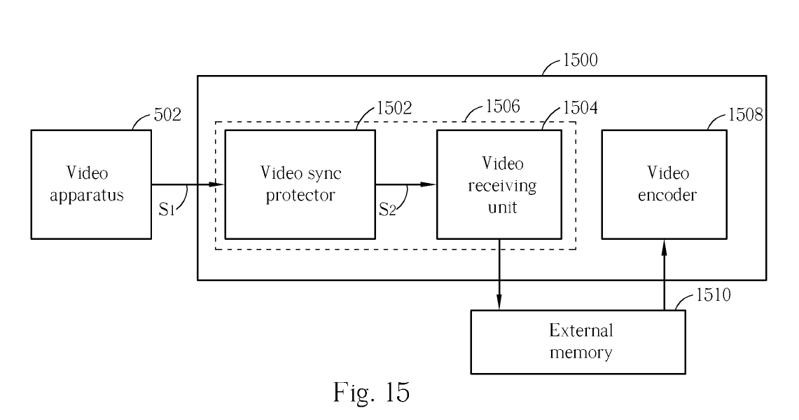

FIG. 15 shows a block diagram of a video compression apparatus 1500 having an integrated video sync protector 1502 according to another exemplary embodiment. As shown in FIG. 15, the video compression apparatus 1500 is coupled to the video apparatus 502 and includes the video sync protector 1502, a video receiving unit 1504, a video encoder 1508, and an external memory 1510. In this embodiment, regardless of the video source 502, the video compression apparatus 1500 will be capable of safely encoding the video signal S₁ outputted by the video source 502. Additionally, it should be noted that, in another embodiment, the sync protector 1502 could also be combined with the video receiving unit 1504 as a single block 1506. In both embodiments, the result is that the video receiving unit 1504 will only output active video data to the external memory 1510 for frames having a duration of at least a minimum number of lines required to allow the video encoder 1508 time to encode all macroblocks in the active video. In this way, the video encoder 1508 is able to safely and properly encode the video data corresponding to the output of the video apparatus 502 including during channel changes on the video apparatus 502.

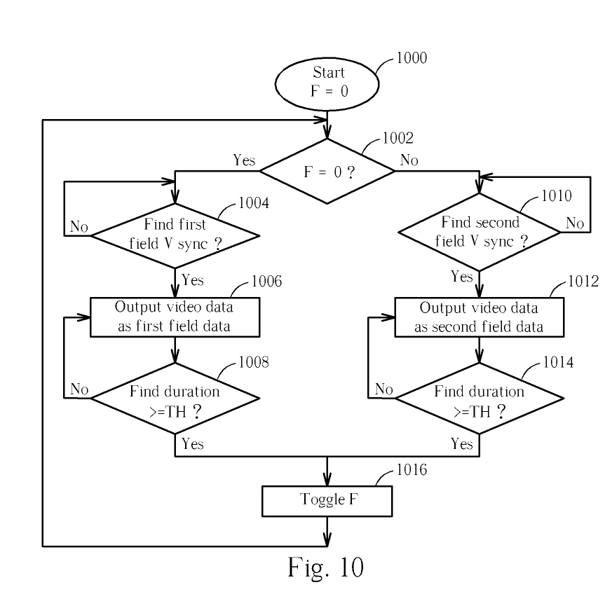

FIG. 10 shows a flowchart describing operations of protecting a video encoder 1508 from receiving invalid fields when encoding video data corresponding to a first video signal S₁ according to a second exemplary embodiment. Provided that substantially the same result is achieved, the steps of the flowchart shown in FIG. 10 need not be in the exact order shown and need not be contiguous, that is, other steps can be intermediate. In this exemplary embodiment, the operations of protecting a video encoder 1508 from receiving invalid fields include the following steps:

Step 1000: Start sync signal protection operations by setting a field variable F equal to 0. The field variable F corresponds to one of the interlaced field in the first video signal S₁ (either F=0 for the first field f1, or F=1 for the second field f2).

Step 1002: Is the field variable F equal to 0? If yes, proceed to step 1004; otherwise, proceed to step 1010.

Step 1004: Find the vertical sync Vsync for the first field f1 in the first video signal S₁. That is, receive the video data of the first video signal S₁ and detect a first sync signal in the received video data. If the vertical sync Vsync for the first field f1 is not found, remain at step 1004. When the vertical sync Vsync for the first field f1 in the first signal S₁ is found, proceed to step 1006.

Step 1006: Output the active video data A₁ from first video signal S₁ as the first field f1 video data for the second video signal S₂.

Step 1008: Is the field duration greater than or equal to a threshold Th? This step ensures that all fields in the second video signal S₂ are at least as long as the threshold Th. Therefore, no shortened fields will be present in the second video signal S₂. If the field duration has not exceeded the threshold Th, return to step 1006; otherwise, when the field duration has exceeded the threshold Th, proceed to step 1016.

Step 1010: Find the vertical sync Vsync for the second field f2 in the first video signal S₁. That is, receive the video data of the first video signal S₁ and detect a first sync signal in the received video data. If the vertical sync Vsync for the second field f2 is not found, remain at step 1010. When the vertical sync Vsync for the second field f2 in the first signal S₁ is found, proceed to step 1012.

Step 1012: Output the active video data A₂ from first video signal S₁ as the second field f2 video data for the second video signal S₂.

Step 1014: Is the field duration greater than or equal to a threshold Th? This step ensures that all fields in the second video signal S₂ are at least as long as the threshold Th. Therefore, no shortened fields will be present in the second video signal S₂. If the field duration has not exceeded the threshold Th, return to step 1012; otherwise, when the field duration has exceeded the threshold Th, proceed to step 1016.

Step 1016: Toggle the field variable F to ensure that no repeated field vertical sync Vsync signals will be present in the second video signal S₂. Finally, return to step 1002 to repeat the process of sync signal protection for the toggled field variable F.

The steps of FIG. 10 not only ensure that neither shortened fields nor repeated fields can occur in the second video signal S₂, but also prevent any erroneous video data that may be present in the extended area of a elongated field from being stored in the external memory 1510 or encoded by the video encoder 1508. That is, the video sync protector 1502 receives active video data A₁, A₂ of the first video signal S₁ and outputs the second video signal S₂ having active video data A₁, A₂ corresponding to the active video data A₁, A₂ of the first video signal S₁ only while waiting for the field duration to be greater than or equal to the threshold Th (steps 1006 and 1012). Therefore, through the operations described in FIG. 10, the video encoder 1508 will always be able to safely encode the active video A₁, A₂ of the two interlaced video fields f1, f2 of the second video signal S₂ and will avoid encoding erroneous data after the threshold Th has been reached.

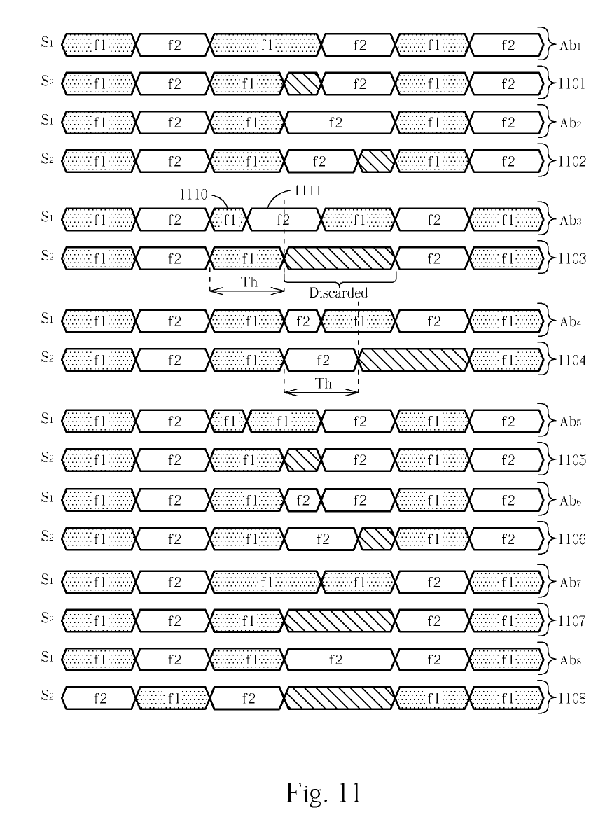

FIG. 11 shows a diagram of the protected second video signal S₂ outputted by the video sync protector 1502 when operating according to the method described in FIG. 10 for each of the abnormal video signals (Ab1 to Ab8) of FIG. 6. As shown in FIG. 11, when the first video signal S₁ is one of the abnormal video signals (Ab1 to Ab8), the video sync protector 1502 outputs a second video signal S₂ being protected according to the operations described in FIG. 10. That is, the second video signals S₂, labeled in FIG. 11 as 1100 to 1108, correspond to the protected versions of the abnormal video signals Ab1 to Ab8, respectively. For example, in this embodiment, when the first video signal S₁ is the third abnormal video signal Ab3, the video sync protector 1502 extends the length of the shortened f1 field 1110 by the threshold Th. During the time that the length of the shortened f1 field 1110 is being extended, the data from first video signal S₁ is outputted as the first field f1 video data for the second video signal S₂ shown video signal 1103 in FIG. 11. Afterwards, the incoming video data of the first video signal S₁ is discarded until, at step 1010, the second field f2 vertical sync Vsync is found. In this way, the video encoder 1508 has ample time to encode the video data of this field and erroneous data after the threshold Th is discarded.

However, in some channel transitions, there is still a small chance that erroneous data will be encoded as active video data A₁, A₂. For example, during the time of the transition between the first f1 field 1110 and the second f2 field 1111 in FIG. 11, black lines will occur in the resulting data encoded by the video encoder 1508. The black lines occur due to the vertical sync Vsync information of the second f2 field 1111 being treated as active video when the encoded field is extended according to the threshold Th.

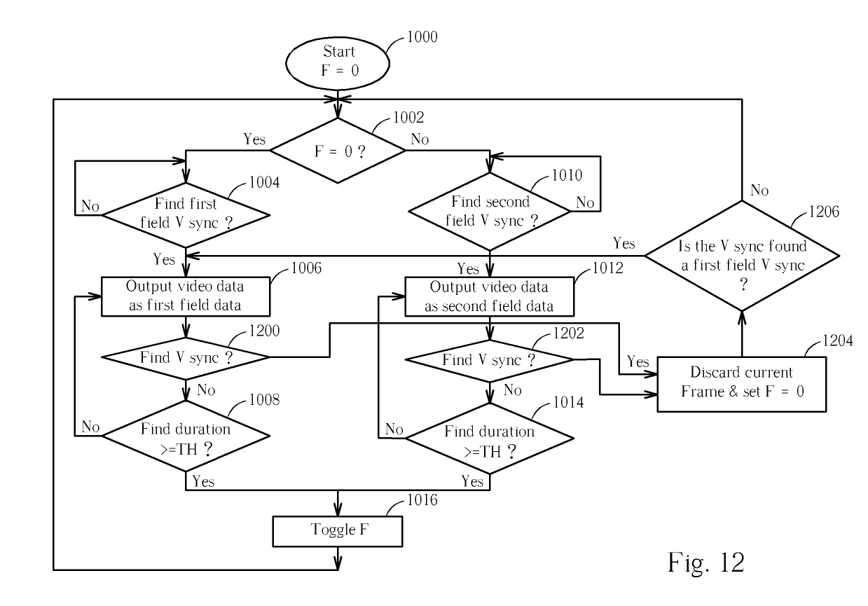

FIG. 12 shows a flowchart describing operations of protecting a video encoder 1508 from receiving invalid fields when encoding video data corresponding to a first video signal S₁ according to a third exemplary embodiment. Provided that substantially the same result is achieved, the steps of the flowchart shown in FIG. 12 need not be in the exact order shown and need not be contiguous, that is, other steps can be intermediate. In this exemplary embodiment, the operations of protecting a video encoder 1508 from receiving invalid fields include the same steps as shown in FIG. 10 in conjunction with the following additional steps:

Step 1200: Is a vertical sync Vsync signal found in the first video signal S₁? If yes, this means the vertical sync Vsync signal has arrived before the field duration has reached the threshold Th. Therefore, the field is actually too short and black lines will result in the encoded data due to encoding the vertical sync Vsync signal as video data. If the vertical sync Vsync signal is found, to prevent the black lines, proceed to step 1204; otherwise, if no vertical sync Vsync is found, continue on to step 1008 as usual.

Step 1202: Is a vertical sync Vsync signal found in the first video signal S₁? If yes, this means the vertical sync Vsync signal has arrived before the field duration has reached the threshold Th. Therefore, the field is actually too short and black lines will result in the encoded data due to encoding the vertical sync Vsync signal as video data. If the vertical sync Vsync signal is found, to prevent the black lines, proceed to step 1204; otherwise, if no vertical sync Vsync is found, continue on to step 1014 as usual.

Step 1204: Discard the entire current frame. That is, do not store the already encoded data for either the first field f1 or the second field f2 for the current frame in the external memory 1510. Instead, reset the field variable F back to 0, and proceed to step 1206. Any data for the current frame that has already been stored in the external memory 1510 can be overwritten in subsequent write operations.

Step 1206: Is the vertical sync Vsync found at step 1200 or step 1202 the vertical sync Vsync for the first field f1 in the first video signal S₁? If no, return to step 1002; otherwise, proceed directly to step 1006.

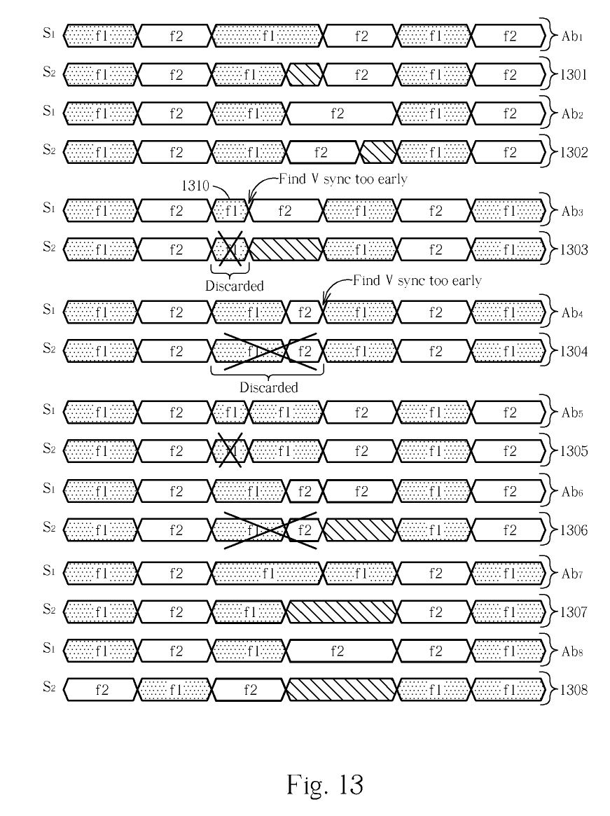

FIG. 13 shows a diagram of the protected second video signal S₂ outputted by the video sync protector 1502 when operating according to the method described in FIG. 12 for each of the abnormal video signals (Ab1 to Ab8) of FIG. 6. As shown in FIG. 13, when the first video signal S₁ is one of the abnormal video signals (Ab1 to Ab8), the video sync protector 1502 outputs a second video signal S₂ being protected according to the operations described in FIG. 12. That is, the second video signals S₂, labeled in FIG. 13 as 1301 to 1308, correspond to the protected versions of the abnormal video signals Ab1 to Ab8, respectively. For example, in this embodiment, when the first video signal S₁ is the third abnormal video signal Ab3, the video sync protector 1502 starts by extending the length of the shortened f1 field 1310 by the threshold hold Th. However, before the threshold Th is reached, a second f2 field 1311 is received at step 1200. Therefore, the full frame including both the first field f1 and the second field f2 are discarded in the resulting second video signal S2 shown as video signal 1303 in FIG. 13.

The additional steps of FIG. 12 prevent any erroneous data from being encoded by the video encoder 1508 because if a second sync signal is detected in the video data of the first video signal S₁ while waiting for the minimum field duration, the video sync protector 1502 discards the current frame in the video data of the second video signal S₂ by not outputting any video data in the corresponding current frame in the second video signal S₂ to the external memory 1510. This ensures that no black lines or other noise are present during playback of the encoded data. In this way, the video encoder 1508 has ample time to encode the video data of this frame, and no erroneous data is encoded either before or after the threshold Th during channel switches.

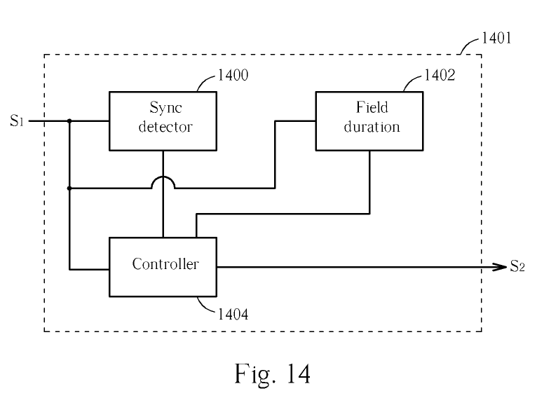

It should also be noted that other embodiments are also possible. For example, although the above description has focused on first and second video signal S₁, S₂ having interlaced fields f1, f2, other embodiments where there is only one field, or more than two fields in the video signals S₁, S₂ are also possible. Additionally, different sync signals other than the vertical sync signals can also be protected in different embodiments. For example, FIG. 14 shows a generalized block diagram of the video sync protector 1401 according to an exemplary embodiment. As shown in FIG. 14, the video sync protector 1401 includes a sync detection unit 1400, a field duration counter 1402, and a controller 1404. The sync detection unit 1400 is coupled to the first video signal S₁ for receiving video data of the first video signal S₁ and detecting a first sync signal in the video data of the first video signal. The field duration counter 1402 is coupled to the first video signal S₁, and the controller 1404 is coupled to the first video signal S₁, the sync detection unit 1400, and the field duration counter 1402.

The controller 1404 outputs a protected sync signal in video data of a second video signal S₂ when the sync detection unit 1400 detects the first sync signal in the first video signal. Then, the controller waits for the field duration counter 1402 to reach a minimum field duration. In this way, because the second video signal S₂ is coupled to the video compression apparatus 504, only protected sync signals will reach the video compression apparatus 504.

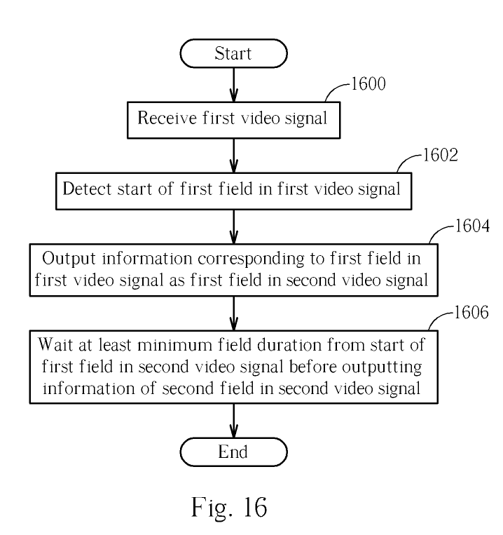

FIG. 16 shows a generalized flowchart describing operations of protecting a video encoder when encoding video data corresponding to a first video signal S₁ according to a fourth exemplary embodiment. Provided that substantially the same result is achieved, the steps of the flowchart shown in FIG. 16 need not be in the exact order shown and need not be contiguous, that is, other steps can be intermediate. In this exemplary embodiment, the operations of protecting a video encoder include the following steps:

Step 1600: Receive a first video signal S₁ from a video apparatus.

Step 1602: Detect a start of a first field in the first video signal S₁. For example, detect a first vertical sync signal in the first video signal S₁.

Step 1604: Output information corresponding to the first field in the first video signal S₁ as a first field in a second video signal S₂. That is, in a first embodiment, output a first sync signal in the second video signal S₂. In another embodiment, output active video of the first field in the second video signal S₂.

Step 1606: Wait at least a minimum field duration from a start of the first field in the second video signal before outputting information of a second field in the second video signal S₂. This step ensures that a video encoder will have sufficient time to fully encode the first field of the second video signal S₂.

The disclosure describes a method and related video sync protector for protecting a video encoder from receiving an invalid sync signal while encoding video data corresponding to a first video signal. By receiving the video data of the first video signal, detecting a first sync signal in the video data of the first video signal, outputting a protected sync signal in video data of a second video signal when the first sync signal is detected in the first video signal, waiting for a minimum field duration, and coupling the second video signal to the video encoder, the method and related video sync protector ensure that no invalid sync signals will reach a video encoder. This increases the stability of the video encoder and also prevents erroneous data from being encoded by the video encoder during channel switches that cause synchronization timing differences in the first video signal.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of protecting a video encoder while encoding video data corresponding to a first video signal, the method comprising:
receiving the first video signal;
detecting a start of a first field in the first video signal;
outputting information corresponding to the first field in the first video signal as a first field in a second video signal; and
waiting at least a minimum field duration from a start of the first field in the second video signal before outputting information of a second field in the second video signal.

2. The method of claim 1, wherein the second video signal is coupled to the video encoder.

3. The method of claim 1, further comprising:
detecting the start of the first field in the first video signal being a first sync signal of the first video signal; and
when the first sync signal is detected in the first video signal, outputting a protected sync signal as the start of the first field in the second video signal.

4. The method of claim 3, wherein the first sync signal is a vertical sync signal received in video data of the first video signal, and the protected sync signal is a vertical sync signal outputted in video data of the second video signal.

5. The method of claim 4, wherein waiting for the minimum field duration further comprises:
initializing a line count variable;
finding a horizontal sync signal in the first video signal;
each time a horizontal sync signal is found in the first video signal, incrementing the line count variable; and
waiting until the line count variable is equal to or greater than a predetermined threshold.

6. The method of claim 3, wherein waiting for the minimum field duration further comprises waiting for the minimum field duration before outputting a second protected sync signal for a second field of the second video signal.

7. The method of claim 3, further comprising:
providing a field variable having a plurality of possible states;
if the first sync signal is for a field in the first video signal matching a current state of the field variable, outputting the protected sync signal in video data of the second video signal for the field corresponding to the current state of the field variable; and
changing the state of the field variable after outputting the protected sync signal in the video data of the second video signal.

8. The method of claim 7, wherein the field variable has two possible states for indicating either a first field or a second field respectively corresponding to interlaced fields in the video data of the first and second video signals; and changing the state of the field variable after outputting the protected sync signal in the video data of the second video signal further comprises toggling the state of the field variable.

9. The method of claim 1, further comprising while waiting for the minimum field duration, receiving active video data for the first field of the first video signal and outputting the first field of the second video signal having active video data corresponding to the active video data of the first video signal.

10. The method of claim 1, further comprising if a start of a second field is detected in the first video signal while waiting for the minimum field duration, discarding a current frame in the video data of the second video signal by not outputting any video data in a corresponding frame in the second video signal.

11. The method of claim 10, further comprising if a start of a second field is not detected in the first video signal while waiting for the minimum field duration, while waiting for the minimum field duration, receiving active video data of the first video signal and outputting the first field of the second video signal having active video data corresponding to the active video data of the first video signal.

12. A video sync protector for protecting a video encoder while encoding video data corresponding to a first video signal, the video sync protector comprising:
a sync detection unit coupled to the first video signal for receiving video data of the first video signal and detecting a start of a first field in the video data of the first video signal;
a field duration counter coupled to the first video signal; and
a controller coupled to the first video signal, the sync detection unit, and the field duration counter for outputting information corresponding to the first field in the first video signal as a first field in a second video signal after the sync detection unit detects the first sync signal in the first video signal, and for waiting at least until the field duration counter reaches a minimum field duration before outputting information of a second field in the second video signal.

13. The video sync protector of claim 12, wherein the second video signal is coupled to the video encoder.

14. The video sync protector of claim 12, wherein the sync detection unit is further for detecting the start of the first field in the first video signal being a first sync signal of the first video signal; and the controller is further for outputting a protected sync signal as the start of the first field in the second video signal when the sync detection unit detects the first sync signal in the first video signal.

15. The video sync protector of claim 14, wherein the first sync signal is a vertical sync signal received in the video data of the first video signal, and the protected sync signal is a vertical sync signal outputted in the video data of the second video signal.

16. The video sync protector of claim 15, wherein the field duration counter is further for initializing a line count variable; finding a horizontal sync signal in the first video signal; incrementing the line count variable each time a horizontal sync signal is found in the first video signal; and waiting until the line count variable is equal to or greater than a predetermined threshold before reaching the minimum field duration.

17. The video sync protector of claim 14, wherein the controller is further for waiting for the field duration counter to reach the minimum field duration before outputting a second protected sync signal in the video data of the second video signal.

18. The video sync protector of claim 14, further comprising:
a field variable having a plurality of possible states coupled to the controller;
wherein if the first sync signal detected by the sync detector is for a field in the first video signal matching a current state of the field variable, the controller is for outputting the protected sync signal in the video data of the second video signal for the field corresponding to the current state of the field variable, and for changing the state of the field variable after outputting the protected sync signal in the video data of the second video signal.

19. The video sync protector of claim 18, wherein the field variable has two possible states for indicating either a first field or a second field respectively corresponding to interlaced fields in the video data of the first and second video signals; and the controller toggles the state of the field variable after outputting the protected sync signal in the video data of the second video signal.

20. The video sync protector of claim 12, wherein while waiting until the field duration counter reaches the minimum field duration, the controller is for receiving active video data for the first field of the first video signal and outputting the first field of the second video signal having active video data corresponding to the active video data of the first video signal.

21. The video sync protector of claim 12, wherein if a start of a second field is detected in the video data of the first video signal while waiting until the field duration counter reaches the minimum field duration, the controller is further for discarding a current frame in the video data of the second video signal by not outputting any video data in a corresponding frame in the second video signal.

22. The video sync protector of claim 21, wherein if a start of a second field is not detected in the first video signal while waiting until the field duration counter reaches the minimum field duration, the controller is further for receiving active video data of the first video signal and outputting the second video signal having active video data corresponding to the active video data of the first video signal while waiting for the field duration counter to reach the minimum field duration.
